(19) United States
(12) Patent Application Publication
(10) Pub. No.: US 2024/0185278 A1
(43) Pub. Date: Jun. 6, 2024

(54) DYNAMIC PERMUTATION DATA TRANSFORMATION SYSTEMS, APPARATUSES, AND METHODS OF USING THE SAME

(71) Applicant: Thumbtack, Inc., San Francisco, CA (US)

(72) Inventors: Bharadwaj Ramachandran, North Brunswick, NJ (US); George Holderness, San Francisco, CA (US); Jeffrey Schmitz, Everett, WA (US); Navneet Rao, San Francisco, CA (US); Thomas Shull, Palo Alto, CA (US); Richard Demsyn-Jones, Toronto (CA)

(21) Appl. No.: 18/529,361

(22) Filed: Dec. 5, 2023

Related U.S. Application Data
(60) Provisional application No. 63/430,638, filed on Dec. 6, 2022.

(51) Int. Cl. G06F 17/14

(52) U.S. Cl. CPC G06F 17/14

(57) ABSTRACT

Various implementations disclosed herein include systems, apparatuses, and methods to determine, for a category, a plurality of first values and a plurality of second values, wherein respective first values from the plurality of the first values and respective second values from the plurality of the second values are associated with respective permutations of parameters associated with the category, determine, based on the plurality of first values and the plurality of second values, a plurality of third values, determine, based on the plurality of third values, a minimum value and a maximum value, obtain, via a user interface, first data associated with the category, determine, based on the minimum value, the maximum value, and the first data, a scale factor, adjust, based on the scale factor, the plurality of third values to obtain a plurality of fourth values, and output the plurality of fourth values.

### CROSS-REFERENCE TO RELATED APPLICATIONS

This patent claims the benefit of U.S. Provisional Application No. 63/430,638 entitled “Dynamic Permutation Data Transformation Systems, Apparatuses, And Methods Of Using The Same” and filed Dec. 6, 2022. U.S. Provisional Application No. 63/430,638 is hereby incorporated by reference herein in its entirety.

### TECHNICAL FIELD

The present disclosure generally relates to dynamic permutation data transformation systems, apparatuses, and methods of using the same.

### BACKGROUND

Various techniques are used to provide interactive platforms for identifying, enabling, and performing services. In some cases, source data may be entered into such platforms and data may be output from such platforms with a one-to-one correspondence. In other words, multiple inputs of source data may be required in order to produce multiple outputs of data to be applied in different scenarios using such platforms.

### SUMMARY

Various implementations disclosed herein include dynamic mechanisms for transforming a single input from a user into an exhaustive list of parameter permutations associated with unique values that enable the output of multiple results ranked based on respective quality scores and multipliers.

An example method comprises: obtaining, via a user, a scale factor associated with a category; determining, based on historical data and based on the category, a plurality of base values associated with parameter permutations of the category; determining, based on the historical data and a geographic location, a plurality of multipliers; determining, based on the plurality of base values and the plurality of multipliers, a plurality of minimum and maximum values associated with the user for the category; determining, based on quality scores, a rank of users including the user; determining; based on the scale factor and the plurality of minimum and maximum values, a plurality of values associated with the user; determining; based on the values associated with the user and based on the rank of users, an updated rank of users; and outputting, based on the updated rank of users and the values associated with the user, a plurality of user results.

An example system comprises one or more processors; and memory storing instructions that, when executed by the one or more processors, cause the system to: obtain, via a user, a scale factor associated with a category; determine, based on historical data and based on the category, a plurality of base values associated with parameter permutations of the category; determine, based on the historical data and a geographic location, a plurality of multipliers; determine, based on the plurality of base values and the plurality of multipliers, a plurality of minimum and maximum values associated with the user for the category; determine, based on quality scores, a rank of users including the user; determine, based on the scale factor and the plurality of minimum and maximum values, a plurality of values associated with the user; determine, based on the values associated with the user and based on the rank of users, an updated rank of users; and output, based on the updated rank of users and the values associated with the user, a plurality of user results.

In some examples disclosed herein, one or more non-tangible computer readable storage mediums store instructions that, when executed, cause the performance of: obtaining, via a user, a scale factor associated with a category; determining, based on historical data and based on the category, a plurality of base values associated with parameter permutations of the category; determining, based on the historical data and a geographic location, a plurality of multipliers; determining, based on the plurality of base values and the plurality of multipliers, a plurality of minimum and maximum values associated with the user for the category; determining, based on quality scores, a rank of users including the user; determining, based on the scale factor and the plurality of minimum and maximum values, a plurality of values associated with the user; determining, based on the values associated with the user and based on the rank of users, an updated rank of users; and outputting, based on the updated rank of users and the values associated with the user, a plurality of user results.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary system diagram associated with examples disclosed herein.

FIG. 2 illustrates an exemplary graphical user interface associated with examples disclosed herein.

FIG. 3 illustrates an exemplary graphical user interface associated with examples disclosed herein.

FIG. 4 illustrates an exemplary graphical user interface associated with examples disclosed herein.

FIG. 5 illustrates an exemplary graphical user interface associated with examples disclosed herein.

FIG. 6 illustrates an exemplary graphical user interface associated with examples disclosed herein.

FIGS. 7-10 illustrates exemplary flowcharts associated with examples disclosed herein.

FIG. 11 illustrates an exemplary electronic device associated with examples disclosed herein.

FIGS. 12-23 illustrate additional exemplary graphical user interfaces associated with examples disclosed herein.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

In some interactive platforms for identifying, enabling, and performing services, there are both clients and professionals (e.g., service providers). There are many ways in which a client may connect with a professional, however, before such connection the client and the professional may know little to no information about each other. In some such platforms, the client may not be aware of what services the provider provides, including whether that provider provides all permutations of a particular service. Additionally, the professional may not be aware of what services the client is going to request, including whether that client is looking for a particular permutation of a particular service to address a particular client scenario. Indeed, a professional may have to consider preparing an exponentially increasing number of quotes to address possible permutations of particular services that they provide in order to be prepared to respond to a specific client request. And every professional would have to perform such exponential quoting. Not only is such a requirement infeasible, but also the entry of such data into an interactive platform by individual users is demanding in terms of data entry and processing thereof.

In view of this, professionals may only seek to enter minimal amounts of data into such interactive platforms. Such minimal data may not provide accuracy in the services provided by the professional nor enable accurate representations of time, efforts, and costs associated with providing a requested service in a particular client scenario. The systems, apparatuses, and methods disclosed herein enable the accuracy in the services provided by the professional (including all possible permutations of such services based on a single input), the ability to match a specific client request for one specific permutation of a service to a professional providing the specific permutation of the service, and enable accurate representations of time, efforts, and costs associated with providing the one permutation of the service in a particular client scenario. In doing so, the computer processing required to enable and facilitate the connection between client and professional may be reduced through the use of job permutation look up tables that associate costs with possible job permutations across multiple client scenarios, rather than requiring user input in advance across differing permutations of particular client scenarios in anticipation of such scenarios, or requiring user input or computational processing only after specific job permutations become known to the professional and/or the interactive platform. Even further, clients may benefit from connecting with a professional that meets their specific needs with accurate representations of associated costs. Professionals likewise may benefit from growth and visibility.

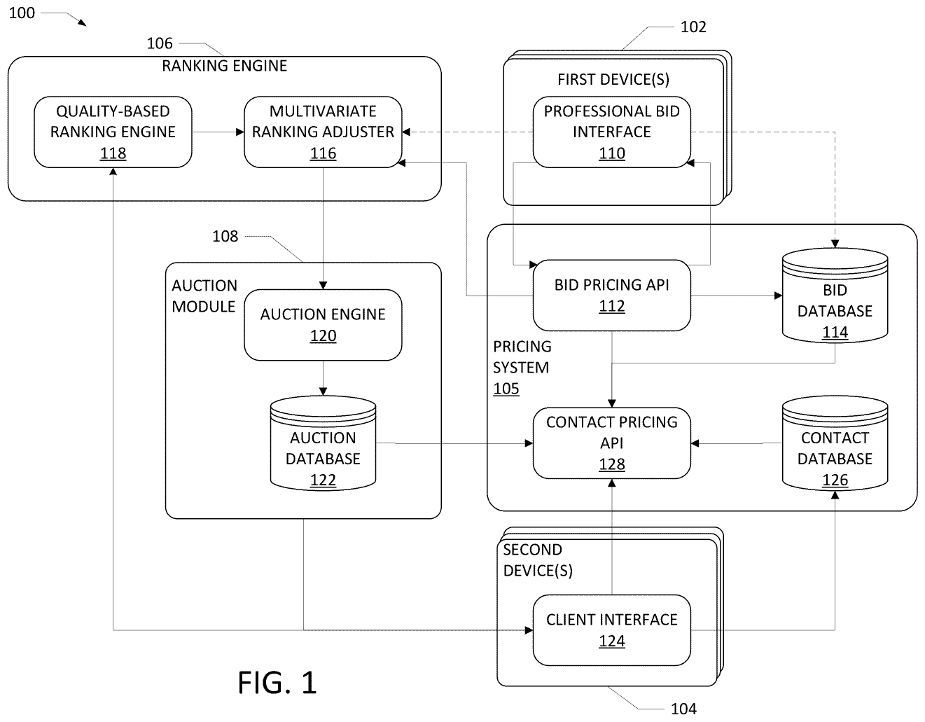

In accordance with the above, FIG. 1 illustrates an exemplary system 100 for correlating user defined inputs to bid permutations based on varying parameters. System 100 may further restructure (e.g., rank) organized data fields based on such correlations. System 100 may output data (e.g., results), which may enable informative decision making capabilities involving the interactions of users. In some examples, the system 100 comprises one or more first devices 102, one or more second devices 104, a pricing system 105, a ranking engine 106, and an auction module 108.

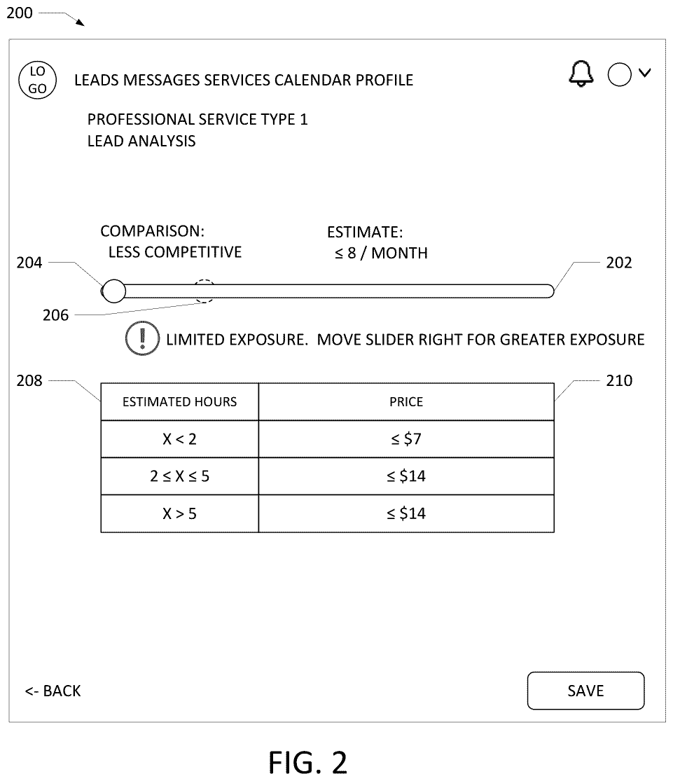

The one or more first devices 102 may comprise a professional bid interface 110. The professional bid interface 110 may interface with professionals offering services such as general contractors, corporate and residential cleaners, painters, electricians, plumbers, welders, architects, carpenters, tilers, mechanics, attorneys, realtors, pest control specialists, movers, landscapers, interior designers, heating ventilation and cooling professionals, drywall specialists, flooring professionals, handy person, writers, accountants, wedding officiants, photographers/videographers, therapists, massage therapists, tailors, instructors, sales person, beauticians, disc jockeys, event planners, chefs, teachers, child care providers, pet care providers, and the like. The professional bid interface 110 may enable professionals to interact with a physical display associated with the one or more first devices 102 via a displayed graphical user interface (GUI). An example GUI enabling professional interaction is illustrated and described with reference to FIGS. 2-6, below. Through the professional bid interface 110, professionals may be able to interact with, among other things, a GUI control such as a slider, to adjust prices associated with various job parameters in a streamlined manner. Because a professional may not exactly know the parameters of a job that a client will request, the methods, systems, and apparatuses described herein enable a professional to create bids for multiple different possible permutation of a job based purely on how the professional interacts with the GUI control (e.g., slider). Although the below examples discuss a slider as an exemplary GUI control, other GUI controls may be used such as buttons, wheels, drop-down lists, textual data inputs, etc.

The pricing system 105 may comprise a bid pricing application programming interface (API) 112 and a bid database 114. As a professional interacts with the professional bid interface 110, the one or more devices 102 may access the bid pricing API 112 to determine pricing data of various categoric parameters of a job based on the position of a cursor associated with the GUI control (e.g., a slider cursor within a slider bar). In some examples, the bid pricing API 112 may transmit the various categoric parameters and associated pricing data to the ranking engine 106. The professional bid interface 110 may enable a professional to store the various categoric parameters and associated pricing data. In some examples, the professional bid interface 110 transmits the various categoric parameters and associated pricing data to the bid database 114 for storage thereof. In some examples, the professional bid interface 110 may transmit the various parameters and associated pricing data to the ranking engine 106. Additionally or alternatively, once the professional chooses to store the various categoric parameters and associated pricing data, an instruction may be sent to the bid pricing API 112 to transmit the various categoric parameters and associated pricing data to the bid database 114 for storage thereof.

The bid pricing API 112 may determine the pricing data based on one or more look up tables (LUT). In some examples, a LUT may comprise base values for given categories (e.g., house cleaning) and associated parameters (e.g., number of bedrooms, frequency of cleaning, square footage, etc.). In some examples, the data in a LUT may be based on historical datasets of job details and values. For example, the base values in a LUT may be based on parameter permutations of jobs in a particular category being mapped to historical job details and prices for jobs in that particular category. In some examples, parameter permutations that may have higher potential value may be assigned a higher base value. Likewise, parameter permutations that may have lower potential value may be assigned a lower base value. For example, Table 1 below illustrates example base values for house cleaning based on a first parameter such as the number of bedrooms, and a second parameter such as the cleaning frequency. As shown in Table 1 below, each permutation of parameters and the associated value may be given a unique identifier (ID), which may be used to distinguish various values and parameter permutations from one another. While two parameters having varying permutations (with corresponding base values) are shown in Table 1, any number of parameters and any number of permutations may be included within one or more LUTs (with their corresponding base values). For example, additional parameters may be included (e.g., home-type, number of floors, type of flooring, etc.) each having their own permutations (e.g., single family home v. multi-family residence, 1-X floors, carpet v. hardwood v. tile v. linoleum v. a combination thereof, etc.) in association with a base value. In the example illustrated in Table 1, additional permutations may include, for the number of bedrooms parameter: a studio permutation, 6+ bedroom permutation, and/or, for the second parameter, more granularity regarding the frequency: once a week, twice a month, every day, every other day, etc. While variables (e.g., BVa-l) are used in Table 1, base values associated with recurring cleanings may be higher than single cleanings (e.g., BVa<BVb, BVc<BVd, BVe<BVf, BVg<BVh, BVi<BVj, BVk<BVl) and base values may increase as the number of bedrooms increases (e.g., BVa<BVc<BVe<BVg<BVi<BVk, BVb<BVd<BVf<BVh<BVj<BVl). In some examples, base values may have a cap such that the base value may not increase even though parameter permutations may change or increase in value (e.g., BVa<BVc<BVe<BVg=BVi=BVk, BVb<BVd<BVf<BVh=BVj=BVl).

TABLE 1
House Cleaning Base Values by Parameter Combinations

| ID | Parameter 1 | Parameter 2 | Base value |
|---|---|---|---|
| 0 | 1 bedroom | One-time | BVa |
| 1 | 1 bedroom | Recurring | BVb |
| 2 | 2 bedrooms | One-time | BVc |
| 3 | 2 bedrooms | Recurring | BVd |
| 4 | 3 bedrooms | One-time | BVe |
| 5 | 3 bedrooms | Recurring | BVf |
| 6 | 4 bedrooms | One-time | BVg |
| 7 | 4 bedrooms | Recurring | BVh |
| 8 | 5 bedrooms | One-time | BVi |
| 9 | 5 bedrooms | Recurring | BVj |
| 10 | 6 bedrooms | One-time | BVk |
| 11 | 6 bedrooms | Recurring | BVl |

In some examples, a LUT may comprise market adjustment multipliers for a given category and a given geographic location. In some examples, the data in a LUT may be based on aggregate historical data about a particular marketplace. For example, market adjustment multipliers in a LUT may be based on supply statistics, demand statistics, and the number of professionals in a given geographic location. In some examples, the data in the LUTs may be static based on prior data analytics. In some examples, the data in the LUTs may be dynamically updated to reflect current market conditions. Table 2 below illustrates example market adjustment multipliers based on geographic location (e.g., state and county). While six different counties for a single state (with corresponding market adjustment multipliers) are shown in Table 2, any number of states and any number of counties (or even more granularly: cities, towns, villages, neighborhoods, etc.) may be included within one or more LUTs (with corresponding market adjustment multipliers). In some examples, while variables (e.g., MAM1-6) are used in Table 2, multipliers in one county (or state, city, town, village, neighborhood, etc.) may vary from multipliers in another county (or state, city, town, village, neighborhood, etc.). In some examples, the market adjustment multipliers have values between zero and one. In some examples, the market adjustment multipliers may have values higher than one.

TABLE 2
House Cleaning Market Adjustment Multipliers
by Geographic Location

| State | County | Market Adjustment Multipliers |
|---|---|---|
| State 1 | County 1 | MAM1 |
| State 1 | County 2 | MAM2 |
| State 1 | County 3 | MAM3 |
| State 1 | County 4 | MAM4 |
| State 1 | County 5 | MAM5 |
| State 1 | County 6 | MAM6 |

In some examples, the bid pricing API 112 determines a reserve value by multiplying a base value in one LUT (e.g., BVa, BVb, BVc, BVd, BVe, BVf, BVg, BVh, BVi, BVj, BVk, or BVl) and a market adjustment multiplier in another LUT (e.g., MAM1, MAM2, MAMA3, MAM4, MAM5, or MAM6). Table 3 below illustrates example reserve values (e.g., RVi-RVxii) determined based on example base values (e.g., BVa-f) and example market adjustment multipliers (e.g., MAM1 and MAM6). In some examples, the unique ID for the reserve values may include a numeral associated with a particular market (e.g., ID 0 with State 1/County 6 and ID 0 with State 1/County 1). In some examples, the unique ID may be purely numerical. One or more LUTs may include reserve values for multiple different combinations of a base value and a market adjustment multiplier for multiple different job categories, including, for example, the example base values from Table 1 and the example market adjustment multipliers from Table 2, and any additional base values and market adjustment multipliers associated with additional possible parameter permutation for additional job categories. The reserve values may be used in association with the GUI control mentioned above, and further described in detail below with respect to FIGS. 2-6. For example, the bid pricing API 112 may determine a minimum value and a maximum value (e.g., opposing ends of the slider function) based on the reserve values for a given category. In some examples, the minimum value may be the lowest reserve value for all geographic locations. In some examples, the minimum value may be the lowest reserve value in a specific geographic location, the lowest reserve value associated with a particular job category, an arbitrary minimum value determined by a user, or the like. In some examples, the maximum value may be a multiple (e.g., 3 times) of the highest reserve value for all geographic locations. In some examples, the maximum value may be based on the highest reserve value in a specific geographic location, the highest reserve value associated with a particular job category, an arbitrary maximum value determined by a user, or the like.

TABLE 3
House Cleaning Reserve Values by Geographic Location and Parameters

| ID | Market | Parameter 1 | Parameter 2 | Base Value | Multiplier | Reserve Value |
|---|---|---|---|---|---|---|
| 0 | State 1/County 6 | 1 bedroom | One-time | BVa | MAM6 | RVi |
| 1 | State 1/County 6 | 1 bedroom | Recurring | BVb | MAM6 | RVii |
| 2 | State 1/County 6 | 2 bedrooms | One-time | BVc | MAM6 | RViii |
| 3 | State 1/County 6 | 2 bedrooms | Recurring | BVd | MAM6 | RViv |
| 4 | State 1/County 6 | 3 bedrooms | One-time | BVe | MAM6 | RVv |
| 5 | State 1/County 6 | 3 bedrooms | Recurring | BVf | MAM6 | RVvi |
| 0 | State 1/County 1 | 1 bedroom | One-time | BVa | MAM1 | RVvii |
| 1 | State 1/County 1 | 1 bedroom | Recurring | BVb | MAM1 | RVviii |
| 2 | State 1/County 1 | 2 bedrooms | One-time | BVc | MAM1 | RVix |
| 3 | State 1/County 1 | 2 bedrooms | Recurring | BVd | MAM1 | RVx |
| 4 | State 1/County 1 | 3 bedrooms | One-time | BVe | MAM1 | RVxi |
| 5 | State 1/County 1 | 3 bedrooms | Recurring | BVf | MAM1 | RVxii |

In some examples, the bid pricing API 112 may determine a default value (e.g., at or between the minimum and the maximum values) for an initial position of or setting of the GUI control. In some examples, the default value may be the same value as the minimum value described above. In some examples, the default value may be the lowest reserve value in the most expensive market. In some examples, the default value may be based on user preferences. In some examples, the default value may be determined based on historical user input. In some examples, the default value may be selected to create a minimum amount of competition among professionals in a given category in a given geographic location. The minimum, maximum, and default values may be sent from the bid pricing API 112 to the professional bid interface 110.

The professional bid interface 110 may display the GUI control in accordance with the minimum, maximum, and default values determined by the bid pricing API 112. In some examples, the professional bid interface 110 displays a slider bar having the minimum and maximum values described above, and a slider cursor located on the slider bar at the default value. In order to determine a particular bid when the slider cursor is at any given position on the slider bar, the professional bid interface 110 may interact with the bid pricing API 112 to interpolate a bid using Equation 1 below. These interpolated values may enable display of maximum values for multiple different permutations of parameters of a particular job category at any point on the slider bar without prior calculation of such values. In reference to Equation 1 below, bid^{ID} refers to a particular bid for a particular job category having a particular parameter permutation identifiable by a unique ID. In some examples, min Bid^{ID} refers to a minimum value for the particular job category having the particular parameter permutation identified with the unique ID. In some examples, max Bid^{ID} refers to a maximum value for the particular job category having the particular parameter permutation identified with the unique ID. In some examples, sliderPosition is a variable with values between (and including) zero and one that correspond to the current position of the slider cursor relative to the slider bar.

bid^{ID}=min Bid^{ID}+(max Bid^{ID}−min Bid^{ID})*sliderPosition Equation 1

In some examples, the sliderPosition may correspond to a scale factor input via a user in association with a selected job category in order to determine various bids associated with multiple permutations of the selected job category. In some examples, GUI controls other than the slider cursor and slider bar may comprise ranges of position, drop-down lists, numeric or alphanumeric “text boxes”, “combo boxes,” and the like which may allow a user to input the scale factor (e.g., sliderPosition) that may vary one or more bid values associated with the user, one for each of the multiple different permutations of parameters of the particular job category (e.g., to vary the Bid^{ID} for each permutation of parameters between a respective min Bid^{ID} and max Bid^{ID} for that permutation of parameters under the category).

In addition to the GUI control, the professional bid interface 110 may display a table presenting the one or more bid values (e.g., maximum values) for multiple different permutation of parameters of the particular job category, which may be updated and vary according to changes in the current position or setting of the GUI control. Users may, for example, interact with the aforementioned slider cursor to move the slider cursor left (e.g., toward the minimum value) or right (e.g., toward the maximum value). As the user interacts with the slider cursor, the presented values in the table for each of the multiple different permutations of parameters may be updated (e.g., contemporaneously).

In some examples, a user may choose to store the slider cursor position (e.g., scale factor), the one or more bid values in the associated table, or a combination thereof. In some examples, the slider cursor position and the data values in the associated table currently displayed via the professional bid interface 110 may be stored within the bid database 114. In some examples, the bid database 114 includes the unique ID for each value and associated parameter permutation. In some examples, the bid database 114 stores an aggregated bid multiplier as a floating point representation of the average of each of the professional's bids (as determined by Equation 1 for each unique ID) divided by the base value associated with the same unique ID for a given category. In some examples, the GUI control may display the bid multiplier. In some such examples, as the GUI control is changed, the bid multiplier may be updated on the display as either increasing (e.g., as a slider is moved rightward) or decreasing (e.g., as a slider is moved leftward). In some examples, rather than a slider bar and slider cursor, the bid multiplier may be displayed with “−” and “+” buttons to increase or decrease the bid multiplier. Equation 2 below illustrates an example of such an aggregated bid multiplier using the bid^{ID} from Equation 1 and a corresponding base value for the particular job category having the particular parameter permutation from an appropriate LUT (e.g., a base value as set forth in Table 1 identified with the unique ID).

bidMultiplier=avg(bid^{ID}/baseValue^{ID}) Equation 2

In some examples, the ranking engine 106 receives the various parameters (e.g., geographic market, number of bedrooms, frequency of cleaning, and/or the unique identifier associated with such parameter permutations) and associated pricing data (e.g., bid^{ID}, bidMultiplier) selected by a user via the professional bid interface 110 (and stored in the bid database 114). The ranking engine 106 may comprise a multivariate ranking adjuster 116, which may receive the parameters and associated pricing data transmitted from the professional bid interface 110 (or the bid pricing API 112) to the ranking engine 106. The ranking engine 106 may further comprise a quality-based ranking engine 118, which may determine a quality score for a given professional. In some examples, the quality-based ranking engine 118 determines the quality score of a given professional using one or more machine learning algorithms. In some examples, the quality-based ranking engine 118 determines the quality score of a given professional based on the probability that a user will contact or book a professional. In some examples, the quality-based ranking engine 118 determines the quality score of a given professional based on a first probability that a user will contact a professional given that the user viewed that professional, and based on a second probability that the professional will respond to the user based on such contact. In some examples, one or more probabilities may be based on a quantity of jobs completed by a professional. In some examples, one or more probabilities may be based on a number of job categories in which a professional offers services. In some examples, the quality score may be determined based on multiplication of the first probability and the second probability. Such probabilities may be determined based on one or more machine learning algorithms such as logistic regression, which may model probabilities of an event taking place by having log-odds for the event be a linear combination of one or more independent variables; tree-based models (e.g., XGBoost), which may utilize Gradient Boosting and/or Scikit Learn frameworks; or neural network based models (e.g., DCN-v2), which may automatically and efficiently learn bounded-degree predictive feature interactions. In some examples, historical data such as previous jobs, user reviews, job completion or incompletion, user selection or non-selection of a professional may be used in association with such machine learning algorithms. Based on this determined quality score for each professional, the quality-based ranking engine 118 may rank professionals, for a given category, in an order (e.g., descending) based on the determined respective quality scores. In some examples, further information may be used to rank professionals (and may be used with the underlying machine learning algorithms) including, user profile data (e.g., features that relate to the user making a search request such as, for example, past search requests, user details entered into the system 100, aggregated or learned user behavior, etc.), professional profile data (e.g., features that relate to the professional being ranked as a result of the search request such as, for example, past response times to user requests, professional details entered into the system 100, aggregated or learned professional behavior, etc.), and/or search request features (e.g., features that relate to the search request involving a specific user and a list of eligible professionals such as, for example, distance between user and professional, specific job details in search request, computed professional features specific to the search request, etc.). In some examples, the quality-based ranking engine 118 transmits its ranking of professionals and their respective quality score to the multivariate ranking adjuster 116.

In some examples, the multivariate ranking adjuster 116 uses the ranking of professionals (associated with their respective determined quality scores) received from the quality-based ranking engine 118, and uses the various parameters and associated pricing data received from the professional bid interface 110 to determine a quality-adjusted bid for each professional. In some examples, the multivariate ranking adjuster 116 determines the quality-adjusted bid using a multivariate function. For example, Equation 3 below illustrates an example multivariate function for determining quality-adjusted bids, where b represents a bid determined by the bid pricing API 112 (e.g., as set forth in Equation 1), k is a tunable constant, and q represents the quality score determined by the quality-based ranking engine 118. In some examples, bids quality scores may be inversely proportionately weighted according to k. For example, based on the value of k, the quality-adjusted bid can be weighted heavier with respect to the bid data (and thus weighted lower with respect to the quality score), weighted heavier with respect to the quality score (and weighted lower with respect to the bid data), or weighted equally with respect to the bid data and the quality score (e.g., k=0.5). Once the multivariate ranking adjuster 116 has determined the quality-adjusted bids for each professional, the multivariate ranking adjuster 116 may transmit the quality-adjusted bids to the auction module 108.

f(b, q)=b^{k}·q^{(1-k)} Equation 3

In some examples, the auction module 108 comprises an auction engine 120 and an auction database 122. The auction engine 120 may receive the quality-adjusted bids from the multivariate ranking adjuster 116. In some examples, the auction engine 120 stack ranks the professionals according to their respective quality score. In some examples, the auction engine 120 stack ranks the professionals according to their respective quality-adjusted bids. In some examples, the auction engine 120 adjusts the bid of each professional based on a ratio of the respective quality-adjusted bid of that professional to the respective quality-adjusted bid of the professional ranked (e.g., immediately) thereafter. In some examples, the auction engine 120 adjusts the bid of each professional based on a ratio of the respective quality-adjusted bid of that professional to a market driven expected bid (e.g., which may vary dynamically based on market conditions). In some examples, the auction engine 120 determines the minimum value amongst the bid of the professional and a market driven expected bid, and adjusts the bid of the professional to that minimum value. In some examples (e.g., wherein no professional is ranked after another such as where there is only one professional or for the last professional in the stack rank), the auction engine 120 adjusts the bid of a professional based on the reserve price for that professional. Such adjustments (e.g., auctionOutputMultipliers) may be stored in the auction database 122 as auction results. In some examples, no such adjustments are made and the respective quality-adjusted bids for each professional may be stored in the auction database 122 as auction results. In some examples, the auction database 122 transmits the auction results to the pricing system 105.

In some examples, the one or more second devices 104 may comprise a client interface 124. The client interface 124 may enable a user to search for and find a ranked list of professionals capable of providing a requested service. For example, based on search criterion, a user may obtain a list of ranked professionals based purely on quality from the quality-based ranking engine 118. In some examples, the user may obtain a list of professions ranked based on quality and based on bid data from the multivariate ranking adjuster 116, as described above (e.g., via the auction module 108).

In some examples, the pricing system 105 may further comprise a contact database 126, and a contact pricing API 128. Over time, as a user uses the client interface 124, data associated with professionals identified by the user and data associated with the user contacting a professional may be stored within the contact database 126. In some examples, the probability that a professional will be contacted by a user (described above) may be determined (e.g., by the contact pricing API 128) based on such data. For example, such data may be used in the one or more machine learning algorithms (e.g., as training data) described above with reference to the quality score to determine future probability statistics based on historical trends. Similarly, data associated with professionals responding to a user contact may also be stored within the contact database 126. In some examples, the probability that a professional will respond to user contact may be determined (e.g., by the contact pricing API 128) based on such data. For example, such data may be used in the one or more machine learning algorithms (e.g., as training data) described above with reference to the quality score to determine future probability statistics based on historical trends.

In some examples, when a user searches for a particular service, an auction ID may be created and stored in the contact database 126. In some examples, the auction ID identifies the professional(s) located based on the user's search. In some examples, the user may enter specific job parameters into the client interface 124 when searching for a service. In some examples, the specific job parameters may be sent directly to the contact pricing API 128. In some examples, the specific job parameters may be stored in the contact database 124.

In some examples, the contact pricing API 128 uses data from the contact database 124, such as the auction ID and/or specific job parameters entered into the client interface 124, to finalize the results (e.g., final lead price for professional). For example, the contact pricing API 128 matches the specific job parameters (e.g. from the client interface 124 or from the contact database 124) for a particular auction ID to corresponding parameter permutations from the bid pricing API 112 (or the bid database 114), and the contact pricing API 128 obtains from the bid pricing API 112 (or the bid database 114) the respective base values associated with that particular parameter permutation for each professional associated with the auction ID (e.g., basePrice^{ID}). The contact pricing API 128 may further obtain the auction results (e.g., auctionOutputMultipliers) from the auction database 122. Based on Equations 4 and 5 below, the contact pricing API 128 may determine the final result for a given professional. In some examples, once a user contacts a particular professional, the auctionOutputMultiplier associated with that professional from the auction results is used in Equation 4. In some examples, the contact pricing API 128 may use Equation 4 for each auctionOutputMultiplier associated with each professional for a particular auction ID to obtain multiple leadPrices prior to the user contacting a particular professional, and then after the user contacts a particular professional, the leadPrice associated with that particular professional may be used in Equation 5.

leadPrice=floor(basePrice^{ID}*auctionOutputMultiplier) Equation 4

finalLeadPrice=min(leadPrice, bid^{ID}) Equation 5

FIGS. 2-6 illustrate example GUI implementations in accordance with the methods, systems, and apparatuses disclosed herein. For example, FIG. 2 illustrates an example GUI 200 with a slider bar 202, a slider cursor 204, a default slider cursor location 206, and a table 208 with results 210. As discussed above, a user of the GUI 200 may interact with the slider cursor 204 to move it along at various positions on the slider bar 202 (as shown in FIGS. 2-5). As shown in FIG. 2, the slider cursor 204 is at the leftmost side of the slider bar 202 (e.g., the minimum value). Various information may appear as a result of the position of the slider cursor 204 with respect to the slider bar 202. For example, as shown in FIG. 2, because the slider cursor 204 is shown to the left of the default slider cursor location 206 (e.g., below a default value), a notice regarding limitations on a professional's exposure may be presented and displayed. In some examples, display of such information may be informative to assisting a professional to select a particular location on the slide bar 202 to, for example, expand a professional's exposure to one or more markets. Additional information may be displayed for similar purposes. For example, the GUI 200 may display a status “less competitive,” an estimate of a number of leads a professional may expect to receive (e.g., ≤8/month), in addition to various prices in the results 210 portion of table 208 (e.g., ≤$7, ≤$14, ≤$14). Each of the foregoing may be displayed in response to the slider cursor being associated with lower values.

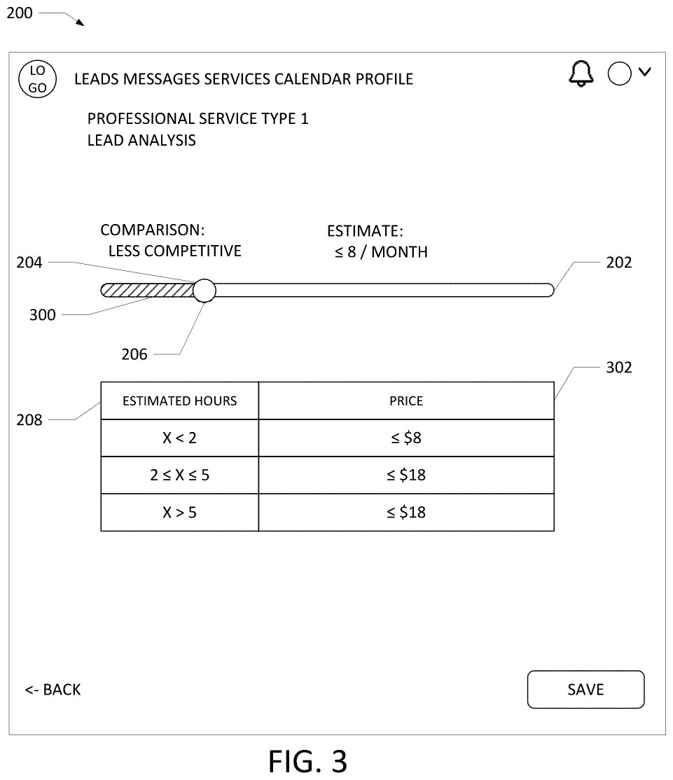

FIG. 3 illustrates the GUI 200 after a user has interacted with the slider cursor 204 by moving the slider cursor 204 rightwardly on the slider bar 202 and to the default slider cursor location 206. In some examples, the GUI 200 may display a shaded portion 300 indicating the progress of the slider cursor 204 towards the rightmost side of the slider bar 202 (e.g., the maximum value). In some examples, because the slider cursor 204 has moved rightwardly (e.g., increased toward the maximum value), the GUI 200 may remove the notice regarding limitations of the professional's exposure and the GUI 200 may display increased prices in an updated results 302 portion of table 208 (e.g., ≤$8, ≤$18, ≤$18). But, the GUI 200 may still display the status “less competitive,” and the same estimate of the number of leads (e.g., ≤8/month).

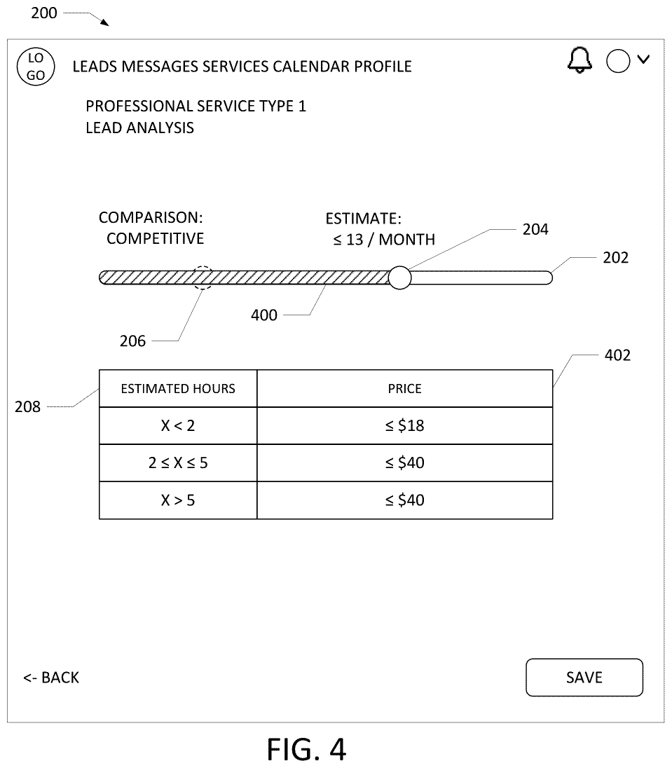

FIG. 4 illustrates the GUI 200 after a user has interacted with the slider cursor 204 by moving the slider cursor 204 rightwardly on the slider bar 202 and beyond the default slider cursor location 206. In some examples, the GUI 200 may display a shaded portion 400 indicating the progress of the slider cursor 204 towards the rightmost side of the slider bar 202 (e.g., the maximum value). In some examples, because the slider cursor 204 has moved rightwardly (e.g., increased toward the maximum value), the GUI 200 may display increased prices in an updated results 402 portion of table 208 (e.g., ≤$18, ≤$40, ≤$40), the GUI 200 may display the status “competitive,” and the GUI 200 may display a new estimate of the number of leads the professional may expect (e.g., ≤13/month).

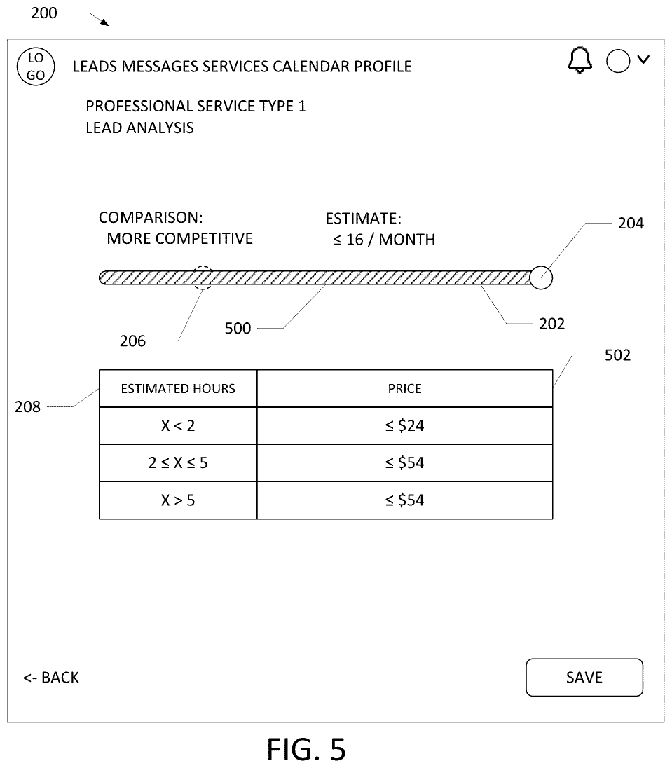

FIG. 5 illustrates the GUI 200 after a user has interacted with the slider cursor 204 by moving the slider cursor 204 rightwardly on the slider bar 202, beyond the default slider location 206, and to the maximum value. In some examples, the GUI 200 may display a shaded portion 500 indicating the progress of the slider cursor 204 up to the rightmost side of the slider bar 202 (e.g., the maximum value). In some examples, because the slider cursor 204 has moved rightwardly (e.g., increased toward the maximum value), the GUI 200 may display increased prices in an updated results 502 portion of table 208 (e.g., ≤$24, ≤$54, ≤$54), the GUI 200 may display the status “more competitive,” and the GUI 200 may display a new estimate of the number of leads the professional may expect (e.g., ≤16/month).

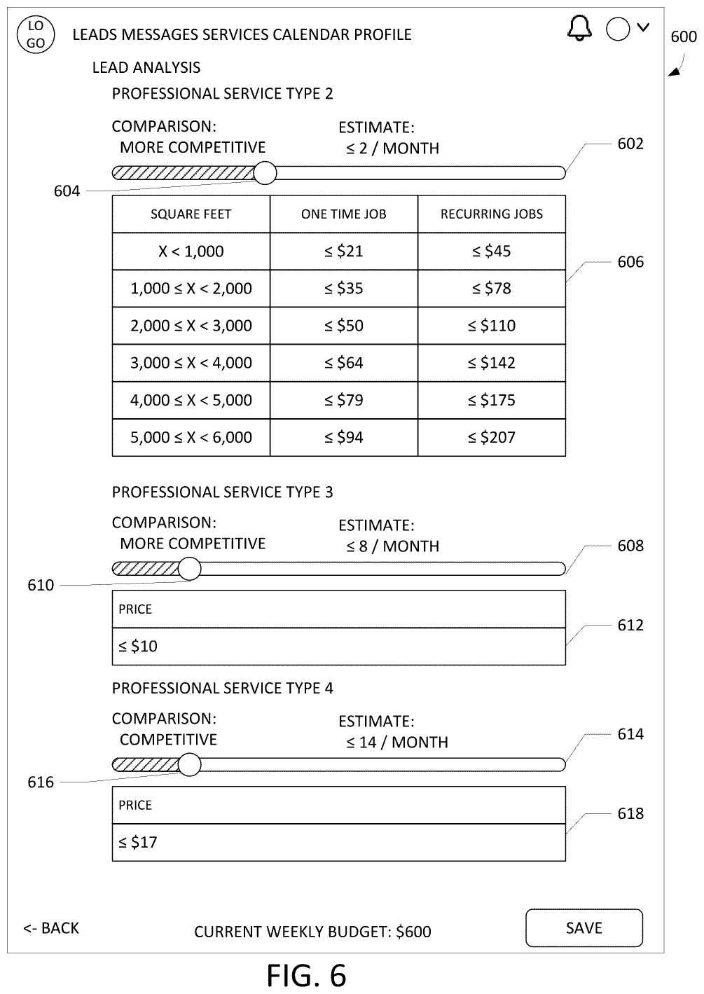

While FIGS. 2-5 illustrate the GUI 200 for a single professional service type (e.g., professional service type 1), FIG. 6 illustrates a GUI 600 with multiple professional service types (e.g., professional service type 2, professional service type 3, professional service type 4) each with their own slider bars, slider cursors, and tables. For example, a first slider bar 602, a first slider cursor 604, and a first table 606 may be associated with a first professional service type. In some examples, a second slider bar 608, a second slider cursor 610, and a second table 612 may be associated with a second professional service type. In some examples, a third slider bar 614, a third slider cursor 616, and a third table 618 may be associated with a third professional service type. Having multiple slider bars, slider cursors, and tables may enable a professional to interact with multiple service categories in a relatively efficient manner. FIG. 6 may further illustrate that the statuses described with reference to FIGS. 2-5 (e.g., less competitive, competitive, more competitive) may be relative to a particular market for a given service. For example, while the second slider cursor 610 may be displayed closer to the leftmost side of the second slider bar 608 (e.g., towards a minimum value), such a slider position may reflect a “more competitive” value in the market associated with the second professional service type. In some examples, because multiple slider bars, slider cursors, and tables are illustrated in GUI 600 and multiple values may be associated with each, the GUI 600 may further display a weekly (or daily or monthly or yearly) budget, which may be a summation of the values associated with the current slider positions of the first slider cursor 604, the second slider cursor 610 and the third slider cursor 616. In some examples, the GUI 600 may display a recommended budget, which may be based on maximum bid amounts determined by the bid pricing API 112 described above. In some examples, the user may select a budget cap, which may prevent one or more sliders from increasing too high (and thus causing the weekly budget to exceed the budget cap). In some examples, users may set an average cost per lead rather than an overall budget cap. In some examples, the bid pricing API 112 may suggest or automatically select slider positions in order to meet or stay within a predetermined budget or average cost per lead.

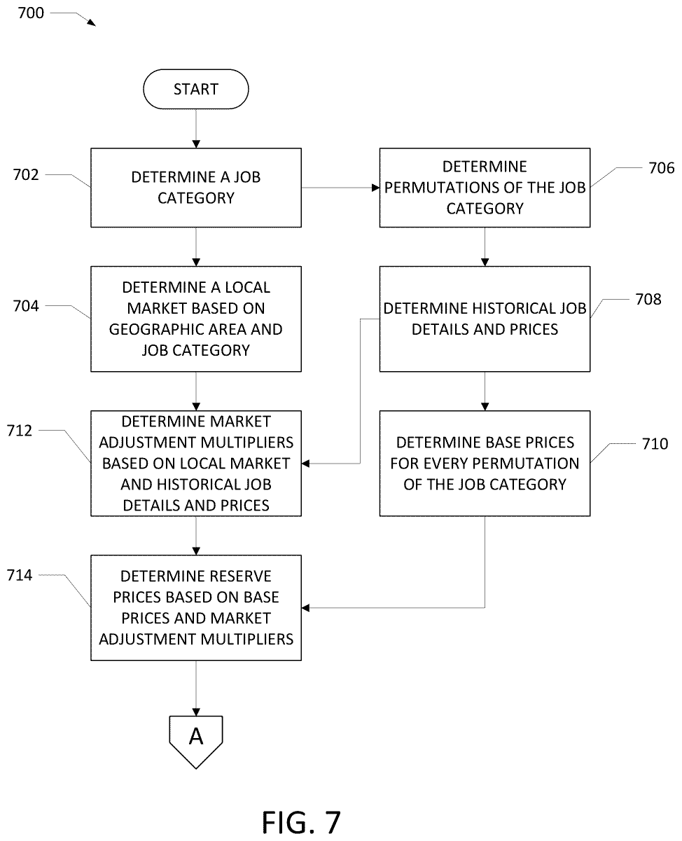

As shown in FIG. 7, a method 700 is provided that may be performed by the bid pricing API 112. At step 702, the bid pricing API 112 may systematically analyze job categories, determining for processing one such job category. The method 700 may be performed multiple times in series or in parallel in order to process each job category. For each determined job category, the bid pricing API 112 may determine a local market based on a geographic area and the job category (step 704). Similarly as in the discussion above, method 700 may be performed multiple times in series or in parallel in order to process each market. The bid pricing API 112 may also determine multiple different possible permutations of the determined job category (step 706). At step 708, the bid pricing API 112 may determine historical job details and prices associated with the determined job category. In some examples, such data may be stored in the bid database 114. Based on the historical job details and prices, the bid pricing API 112 may determine base prices for multiple different possible permutations of the job category, as described above and as shown in Table 1 (step 710). Additionally, the bid pricing API 112 may determine market adjustment multipliers based on the local market and the historical job details and prices (step 712). Thereafter, the bid pricing API 112 may determine reserve prices based on the base prices and the market adjustment multipliers (step 714). In some examples, the reserve prices may be a multiplication of the base prices and the market adjustment multipliers. In some examples, either the base prices or the market adjustment multipliers may be weighted when determining the reserve prices. In some examples, the reserve prices are stored in the bid database 114.

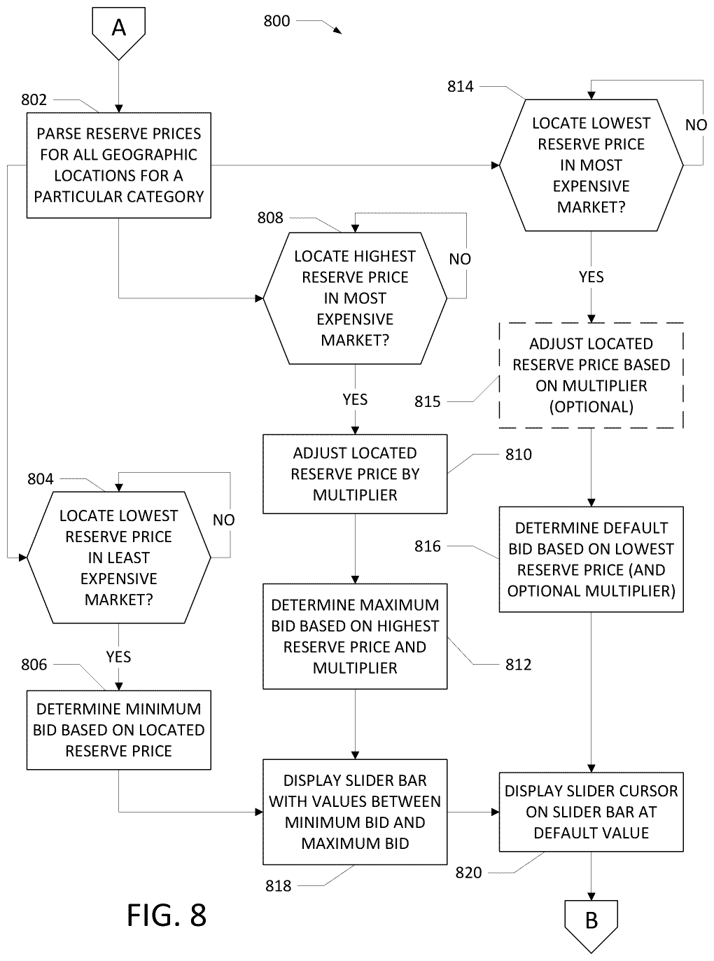

In some examples, method 800 illustrated in FIG. 8 may be performed immediately after method 700. In some examples, method 700 ends and method 800 begins at a subsequent time. At step 802, the bid pricing API 112 may parse the reserve prices for all geographic locations (e.g., after method 700 has been performed for each market) for a particular category. At step 804, the bid pricing API 112 searches for the lowest reserve price in the least expensive market. If the bid pricing API 112 has not yet located the lowest reserve price in the least expensive market (step 804: NO), then control returns to steps 804. If the bid pricing API 112 locates the lowest reserve price in the least expensive market (step 804: YES), then the bid pricing API 112 determines the minimum bid based on the located reserve price (step 806).

Similarly, at step 808 (which may be performed serial to or parallel with step 804), the bid pricing API 112 searches for the highest reserve price in the most expensive market. If the bid pricing API 112 has not yet located the highest reserve price in the most expensive market (step 808: NO), then control returns to steps 808. If the bid pricing API 112 locates the highest reserve price in the most expensive market (step 808: YES), then control proceeds to step 810 where the bid pricing API 112 may adjust that located highest reserve by a multiplier. In some examples, the multiplier may be between zero and one. In some examples, the multiplier may be greater than one (e.g., 1.5×, 1.8×, 2×, 3×, >3×). Thereafter, the bid pricing API 112 determines the maximum bid based on the adjusted located reserve price (step 812).

At step 814 (which may be performed serial to or parallel with step 808), the bid pricing API 112 searches for the lowest reserve price in the most expensive market. If the bid pricing API 112 has not yet located the lowest reserve price in the most expensive market (step 814: NO), then control returns to steps 814. If the bid pricing API 112 locates the lowest reserve price in the most expensive market (step 814: YES), then the bid pricing API 112 may optionally adjust the located reserve price based on a multiplier (optional step 815). In some examples, the multiplier may be between zero and one. In some examples, the multiplier may be greater than one. In some examples, the bid pricing API 112 determines the default bid based on the located reserve price (or the adjusted located reserve price from optional step 815) (step 816). After steps 806, 812, and 816 have been performed (either serially or in parallel), the bid pricing API 112 may transmit the minimum, maximum, and default values to the professional bid interface 110. At step 818, the professional bid interface 110 may display a slider bar starting at the minimum value and extending to the maximum value. At step 820, the professional bid interface 110 may display a slider cursor at the default value (e.g., somewhere between the minimum and maximum values).

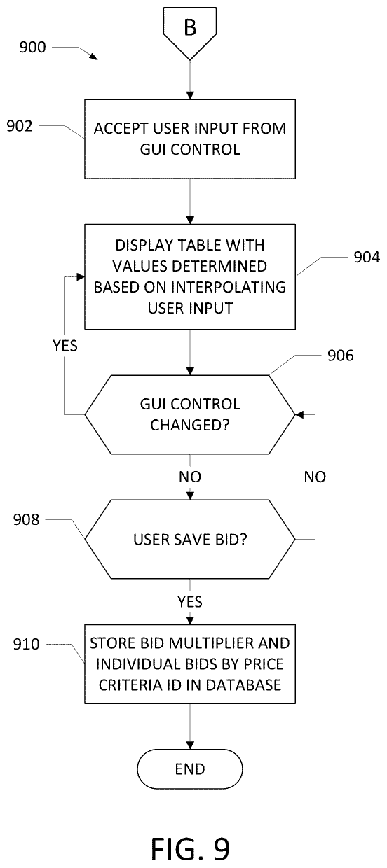

In some examples, method 900 illustrated in FIG. 9 may be performed immediately after method 800. In some examples, method 800 ends and method 900 begins at a subsequent time. At step 902, the professional bid interface 110 may accept user input from the GUI control (e.g., through moving the slider cursor along the slider bar). Based on the user input, the professional bid interface 110 may interact with the bid pricing API 112 to interpolate bid values. In some examples, such interaction uses Equation 1, as described above. Based on the interpolated bid values, the professional bid interface 110 may display a table including such values (step 904). If the professional bid interface 110 determines that the GUI control has changed (step 906: YES), control returns to step 904. If the professional bid interface 110 determines that the GUI control has not changed (step 906: NO), then the professional bid interface 110 determines whether the user has chosen to save their bid (step 908). If the professional bid interface 110 determines that the user has not chosen to save their bid (step 908: NO), control returns to step 908. If the professional bid interface 110 determines that the user has chosen to save their bid (step 908: YES), then the professional bid interface 110 stores the bid multiplier (e.g., as set forth in Equation 2) and the individual bids by price criteria ID (e.g., bid^{ID}) in the bid database 114 (step 910). Thereafter method 900 ends. Of course, methods 700, 800, and 900 may be performed various times and/or may be looped.

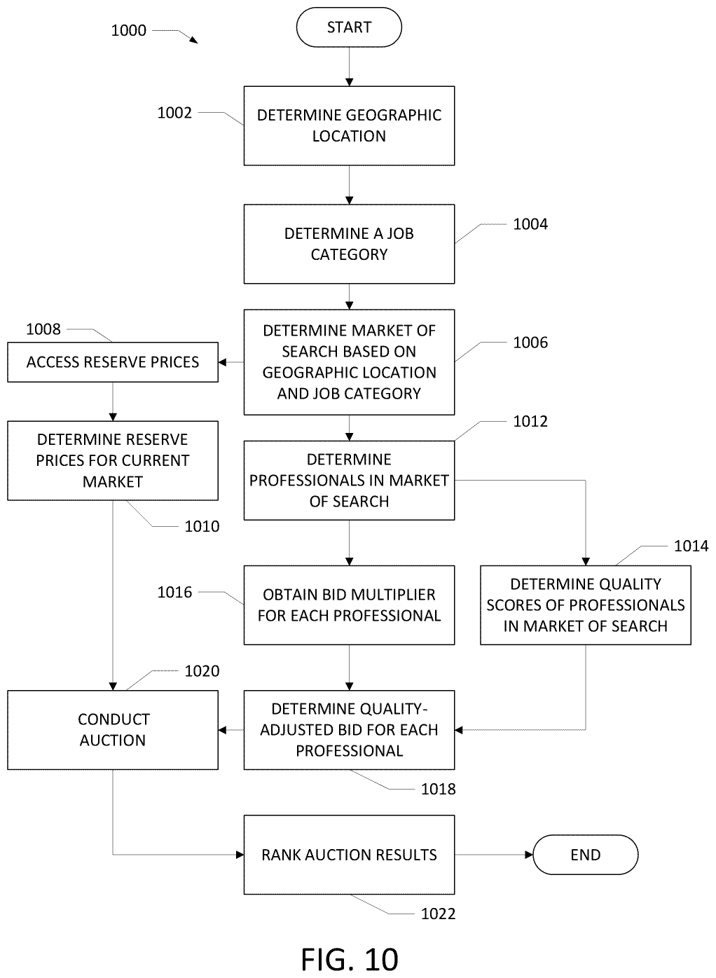

FIG. 10 illustrates an example method 1000 that may be performed by the ranking engine 106 and/or the auction module 108. At step 1002, the ranking engine 106 may determine a geographic location (e.g., based on a client input location from client interface 124). At step 1004, the ranking engine 106 may determine a job category (e.g. based on a client input category from client interface 124). At step 1006, the ranking engine 106 may determine a market of search based on the geographic location and the job category. At step 1008, the multivariate ranking adjuster 116 of the ranking engine 106 may receive or otherwise access the reserve prices from the professional bid interface 110 or the bid database 114. Based on the reserve prices, the multivariate ranking adjuster 116 may determine reserve prices for the current market determined in step 1006 (step 1010). In some examples, the quality-based ranking engine 118 of the ranking engine 106 may determine the professionals in market of search (step 1012) and determine quality scores associated with those professionals (step 1014). The multivariate ranking adjuster 116 may obtain the bid multiplier for each professional from the bid database 114 (step 1016) and may determine (based on the quality scores determined in step 1014 and received from the quality-based ranking engine 118) a quality-adjusted bid for each professional (step 1018). In some examples, at step 1020 the auction module 108 performs an auction based on the quality-adjusted bids for the professionals (step 1020) and ranks the auction results (step 1022). In some examples, the auction may be a first-price auction (e.g., where each bidder is associated with his or her own bid). In some examples, the auction may be a second-price auction (e.g., where the highest bidder is associated with the bid of the second highest bidder, the second highest bidder is associated with the bid of the third highest bidder, and so on and so forth). In some examples, the auction may be a dynamic minimum auction (e.g., where each bid may be the minimum of a current market average and the quality-adjusted bid). Thereafter, method 1000 ends. Of course, method 1000 may be performed various times and/or may be looped.

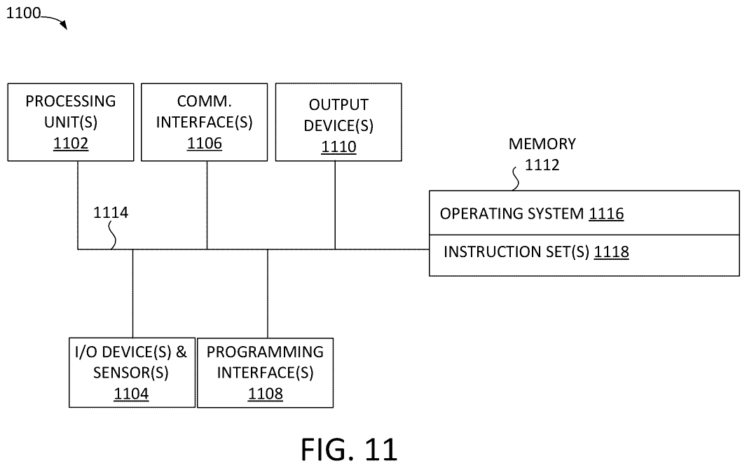

FIG. 11 is a block diagram of electronic device 1100. Device 1100 illustrates an exemplary device configuration for the one or more first devices 102, the one or more second devices 104, the ranking engine 106, and/or the auction module 108. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1100 includes one or more processing units 1102 (e.g., microprocessors, ASICs, FPGAs, GPUs, CPUs, processing cores, and/or the like), one or more input/output (I/O) devices and sensors 1104, one or more communication interfaces 1106 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1108, one or more output device(s) 1110, a memory 1112, and one or more communication buses 1114 for interconnecting these and various other components.

In some implementations, the one or more communication buses 1114 include circuitry that interconnects and controls communications between system components. In some implementations, the one or more I/O devices and sensors 1104 include at least one of an inertial measurement unit (IMU), an accelerometer, a magnetometer, a gyroscope, one or more microphones, one or more speakers, a haptics engine, one or more depth sensors (e.g., a structured light, a time-of-flight, or the like), and/or the like.

In some implementations, the one or more output device(s) 1110 include one or more displays. In some implementations, the one or more output device(s) 1110 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more output device(s) 1110 correspond to diffractive, reflective, polarized, holographic, etc. waveguide displays. In one example, the device 1100 includes a single display.

In some implementations, the one or more output device(s) 1110 include one or more audio producing devices. In some implementations, the one or more output device(s) 1110 include one or more speakers. The one or more output device(s) 1110 may additionally or alternatively be configured to generate haptics.

The memory 1112 includes high-speed random-access memory, such as DRAM, SRAM, DDR RAM, or other random-access solid-state memory devices. In some implementations, the memory 1112 includes non-volatile memory, such as one or more magnetic disk storage devices, optical disk storage devices, flash memory devices, or other non-volatile solid-state storage devices. In some examples, the memory 1112 includes the bid database 114, the auction database 122, and/or the contact database 126. The memory 1112 optionally includes one or more storage devices remotely located from the one or more processing units 1102. The memory 1112 comprises a non-transitory computer readable storage medium.

In some implementations, the memory 1112 or the non-transitory computer readable storage medium of the memory 1112 stores an optional operating system 1116 and one or more instruction set(s) 1118. The operating system 1116 includes procedures for handling various basic system services and for performing hardware dependent tasks. In some implementations, the instruction set(s) 1118 include executable software defined by binary information stored in the form of electrical charge. In some implementations, the instruction set(s) 1118 are software that is executable by the one or more processing units 1102 to carry out one or more of the techniques described herein. The instruction set(s) 1118 may be configured to, upon execution, provide the professional bid interface 110, the bid pricing API 112, the multivariate ranking adjuster 116, the quality-based ranking engine 118, the auction engine 120, the client interface 124, and/or the contact pricing API 128 as described herein, whether in a single device or within respective devices in a single system.

Although the instruction set(s) 1118 are shown as residing on a single device, it should be understood that in other implementations, any combination of the elements may be located in separate computing devices. Moreover, FIG. 11 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

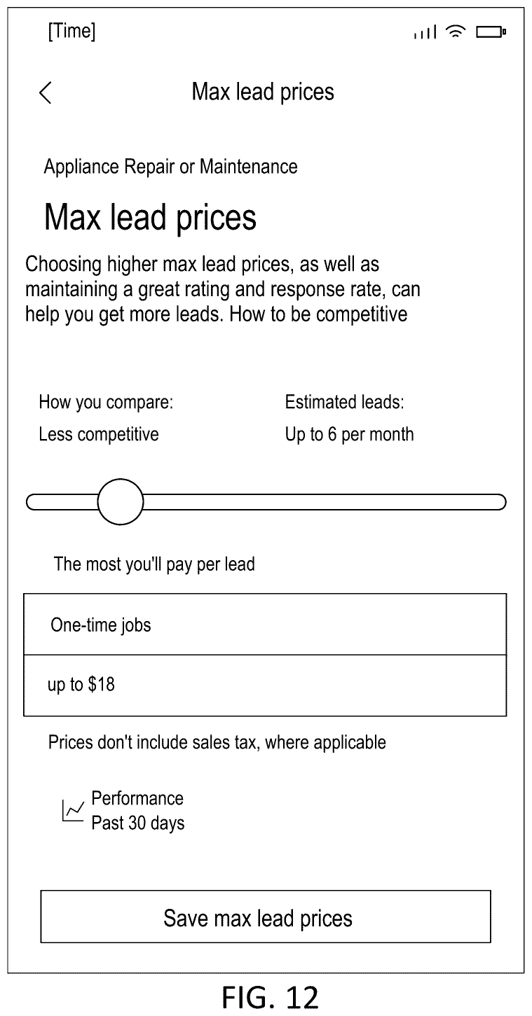

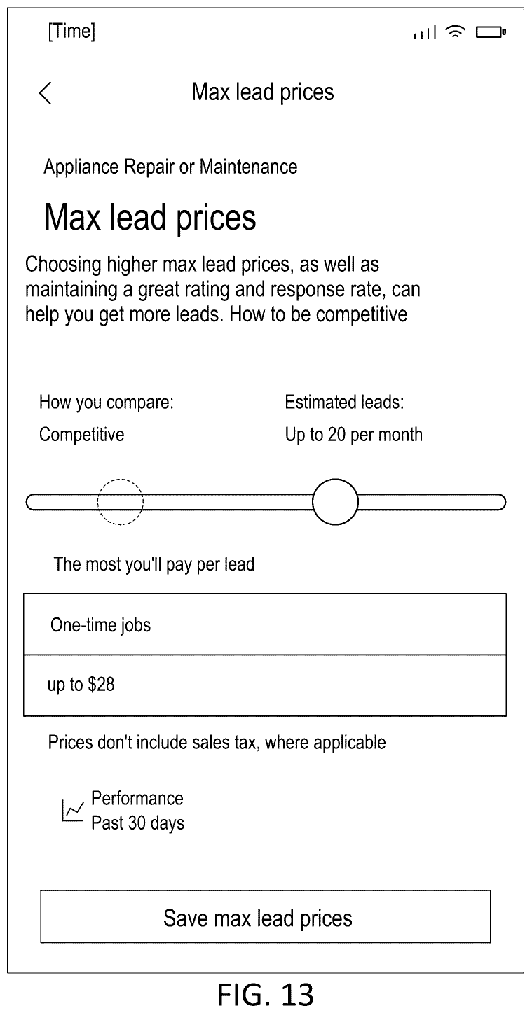

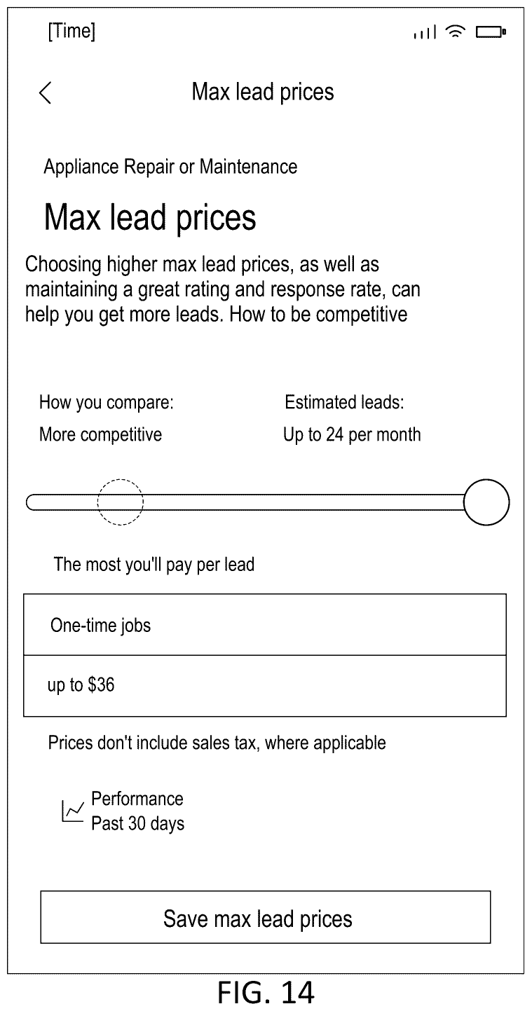

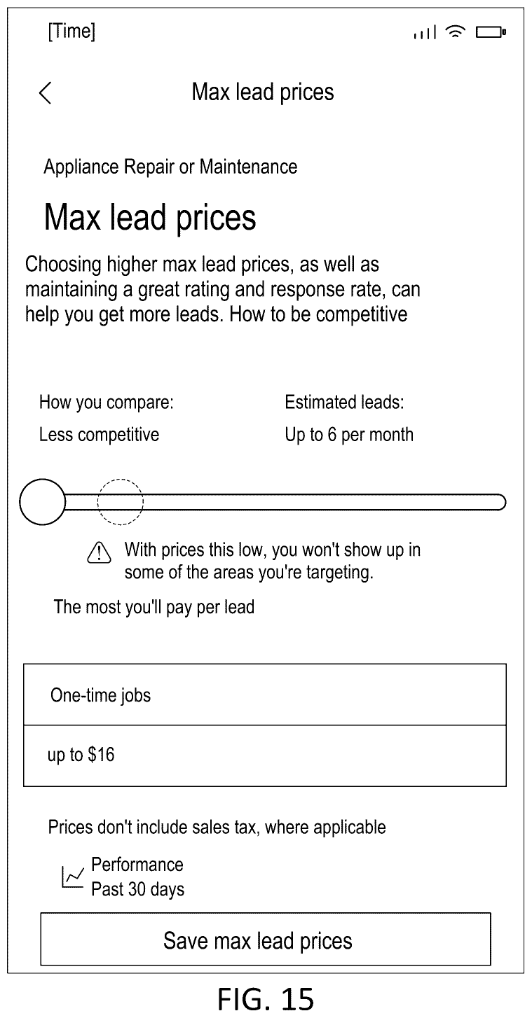

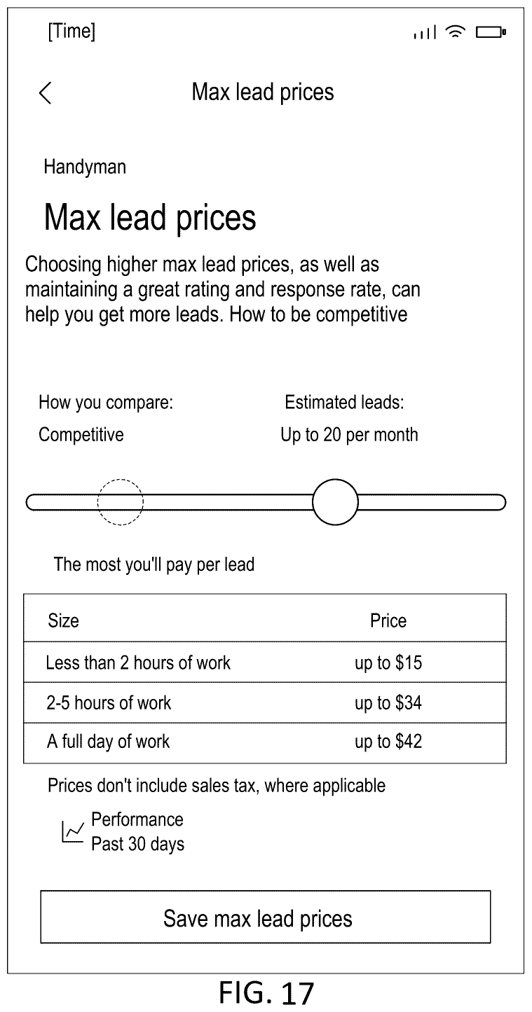

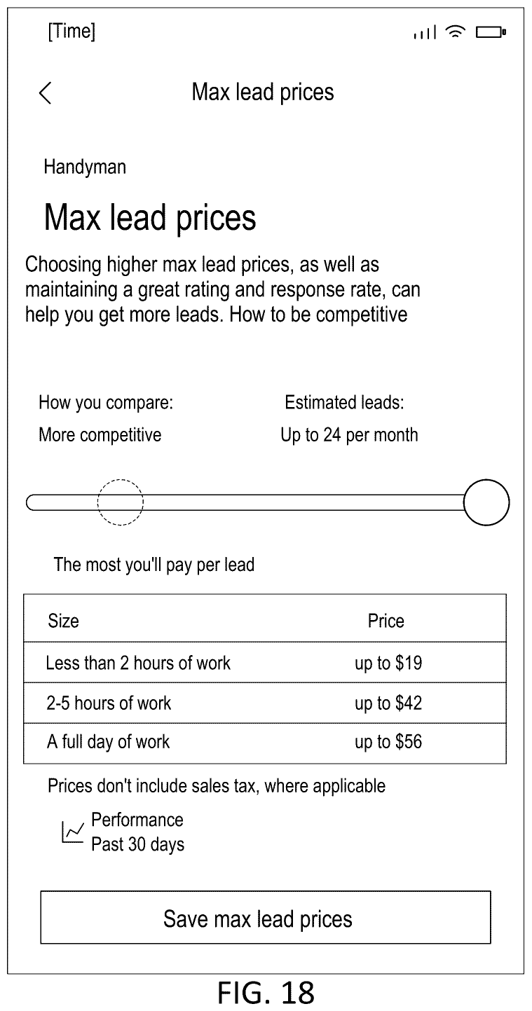

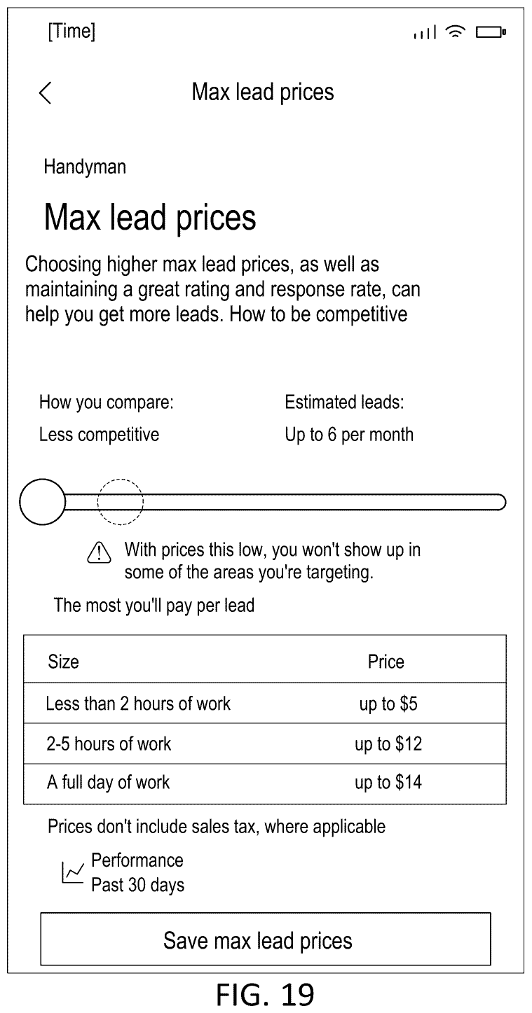

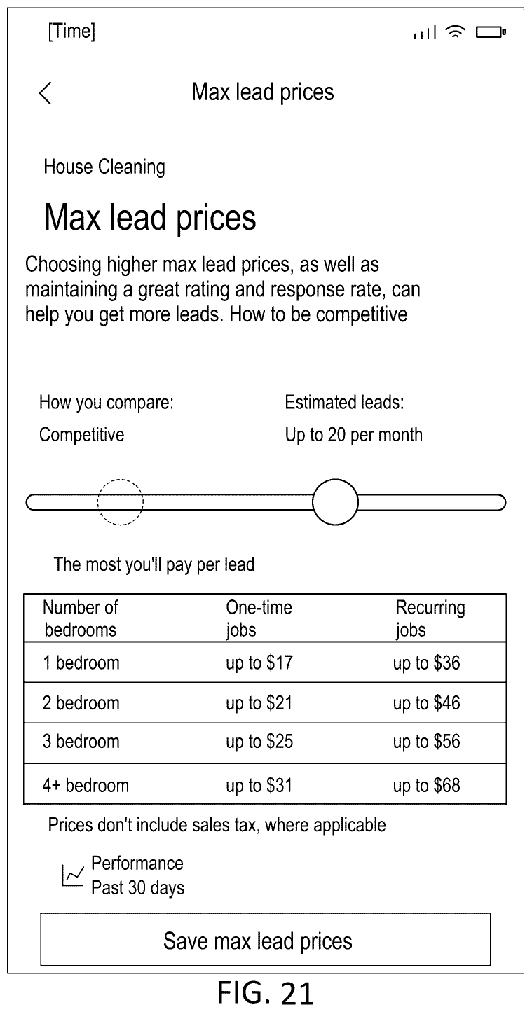

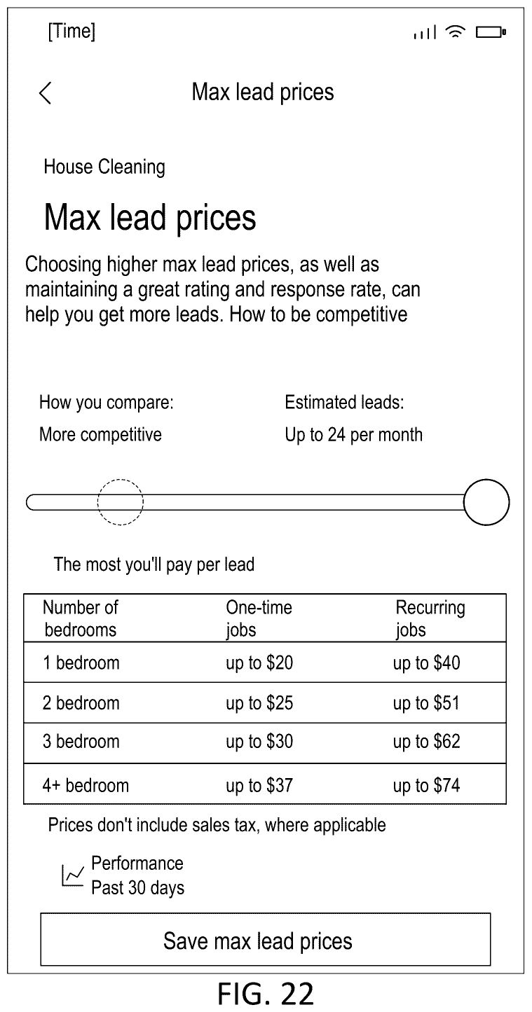

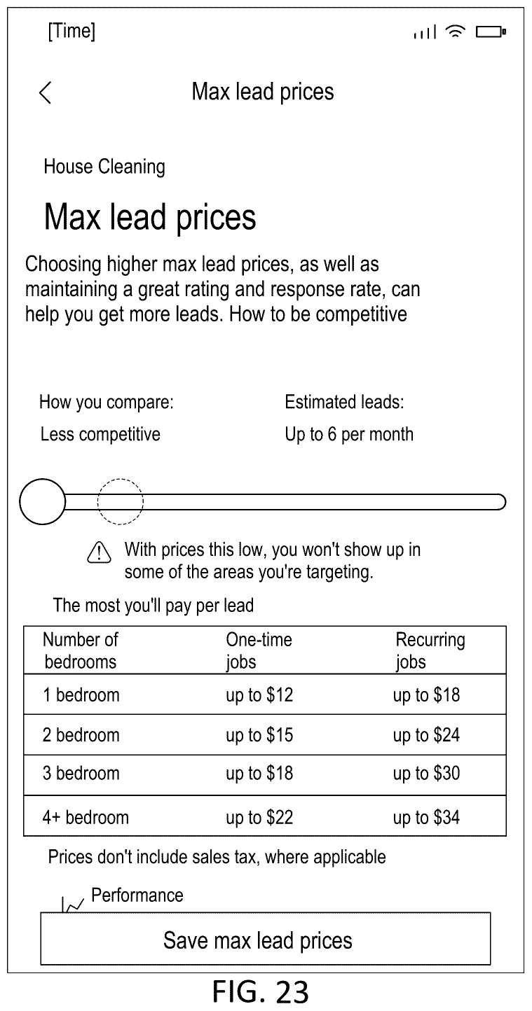

In FIGS. 12-23, additional exemplary graphical user interfaces associated with various alternate job categories and various parameter permutations and bid values are shown. In some examples, such GUIs may correspond with a mobile device implementation of the examples disclosed herein. FIGS. 12-15 illustrate an exemplary GUI that may present a GUI control, a single column comprising parameter permutations (e.g., one-time jobs) and bid values (e.g., up to 18) for a first job category (e.g., Appliance Repair or Maintenance), associated job information (e.g., how you compare, estimated leads, etc.), and a variety of various GUI control positions associated with changes and updates to the associated job information (e.g., less competitive, up to 6 leads per month; competitive, up to 20 leads per month; more competitive, up to 24 leads per month; less competitive, up to 6 leads per month, with prices this low, you won't show up in some of the areas you're targeting) and bid values (e.g., up to 28, up to 36, up to 16).

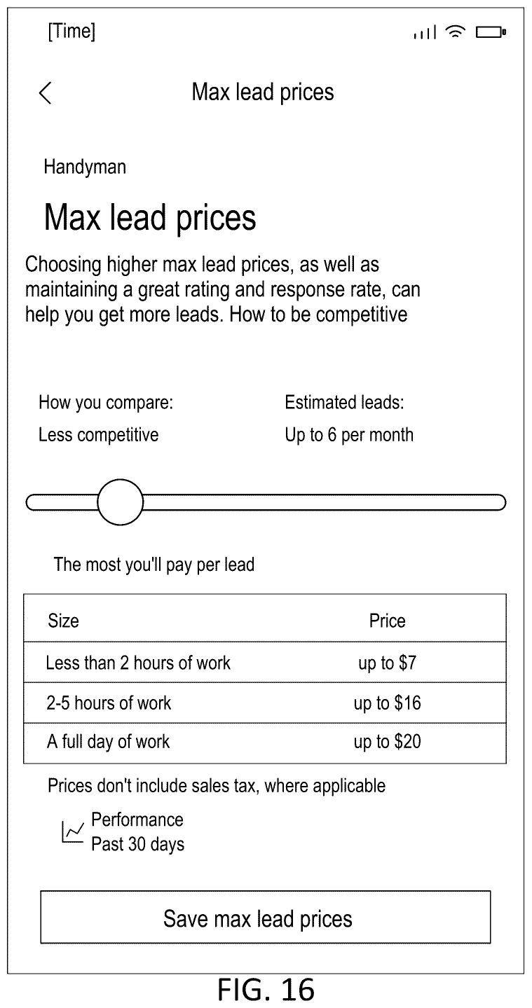

FIGS. 16-19 illustrate an exemplary GUI that may present a GUI control, two columns comprising parameter permutations (e.g., sizes of jobs: less than 2 hours of work, 2-5 hours of work, a full day of work, etc.) and bid values (e.g., up to 7, up to 16, up to 20) for a second job category (e.g., handy person), associated job information (e.g., how you compare, estimated leads, etc.), and a variety of GUI control positions associated with changes and updates to the associated job information (e.g., less competitive, up to 6 leads per month; competitive, up to 20 leads per month; more competitive, up to 24 leads per month; less competitive, up to 6 leads per month, with prices this low, you won't show up in some of the areas you're targeting) and bid values (e.g., up to 15, up to 34, up to 42; up to 19, up to 42, up to 56; up to 5, up to 12, up to 14).

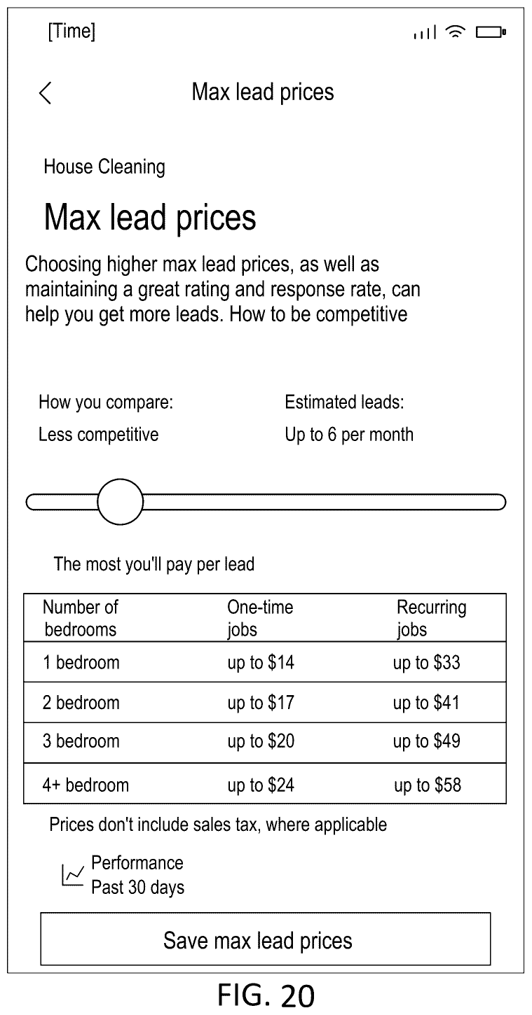

FIGS. 20-23 illustrate an exemplary GUI that may present a GUI control, three columns comprising parameter permutations (e.g., number of bedrooms: 1, 2, 3, 4+, one-time jobs, recurring jobs) and bid values (e.g., one-time jobs: up to 14, up to 17, up to 20, up to 24; recurring jobs: up to 33, up to 41, up to 49, up to 58) for a third job category (e.g., house cleaning), associated job information (e.g., how you compare, estimated leads, etc.), and a variety of GUI control positions associated with changes and updates to the associated job information (e.g., less competitive, up to 6 leads per month; competitive, up to 20 leads per month; more competitive, up to 24 leads per month; less competitive, up to 6 leads per month, with prices this low, you won't show up in some of the areas you're targeting) and bid values (one-time jobs: up to 17, up to 21, up to 25, up to 31; recurring jobs: up to 36, up to 46, up to 56, up to 68; one-time jobs: up to 20, up to 25, up to 30, up to 37; recurring jobs: up to 40, up to 51, up to 62, up to 74; one-time jobs: up to 12, up to 15, up to 18, up to 22; recurring jobs: up to 18, up to 24, up to 30, up to 34).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied; for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
determining, for a category, a plurality of first values and a plurality of second values, wherein respective first values from the plurality of the first values and respective second values from the plurality of the second values are associated with respective permutations of parameters associated with the category;
determining, based on the plurality of first values and the plurality of second values, a plurality of third values;
determining, based on the plurality of third values, a minimum value and a maximum value;
obtaining, via a user interface, first data associated with the category;
determining, based on the minimum value, the maximum value, and the first data, a scale factor;
adjusting, based on the scale factor, the plurality of third values to obtain a plurality of fourth values; and
outputting the plurality of fourth values.

2. The method of claim 1, wherein the plurality of first values comprise historical data associated with the respective permutations of parameters associated with the category.

3. The method of claim 1, wherein the plurality of second values comprise multipliers determined based on market conditions and geographic location.

4. The method of claim 1, wherein the determining the plurality of third values comprises multiplying respective first values from the plurality of first values by respective second values from the plurality of the second values.

5. The method of claim 1, wherein the determining the scale factor comprises interpolating between the minimum value and the maximum value based on the first data.

6. The method of claim 1, wherein the user interface comprises a slider bar and wherein the obtaining the first data associated with the category comprises obtaining a slider cursor position relative to the slider bar.

7. The method of claim 1, further comprising determining, based on the plurality of third values, a plurality of respective minimum values and a plurality of respective maximum values for respective geographic locations.

8. The method of claim 6, wherein the adjusting, based on the scale factor, the plurality of third values to obtain the plurality of fourth values comprises, for each geographic location:
subtracting a respective minimum value from a respective maximum value to obtain a respective delta value;
multiplying the respective delta value by the first data to obtain a respective product value; and
adding the respective minimum value to the respective product value.

9. A system comprising:
one or more processors; and
memory storing computer readable instructions that, when executed by the one or more processors, cause the system to:
determine, for a category, a plurality of first values and a plurality of second values, wherein respective first values from the plurality of the first values and respective second values from the plurality of the second values are associated with respective permutations of parameters associated with the category;
determine, based on the plurality of first values and the plurality of second values, a plurality of third values;
determine, based on the plurality of third values, a minimum value and a maximum value;
obtain, via a user interface, first data associated with the category;
determine, based on the minimum value, the maximum value, and the first data, a scale factor;
adjust, based on the scale factor, the plurality of third values to obtain a plurality of fourth values; and
output the plurality of fourth values.

10. The system of claim 9, wherein the plurality of first values comprise historical data associated with the respective permutations of parameters associated with the category.

11. The system of claim 9, wherein the plurality of second values comprise multipliers determined based on market conditions and geographic location.

12. The system of claim 9, wherein to determine the plurality of third values, the instructions cause the system to multiply respective first values from the plurality of first values by respective second values from the plurality of the second values.

13. The system of claim 9, wherein to determine the scale factor, the instructions cause the system to interpolate between the minimum value and the maximum value based on the first data.

14. The system of claim 9, wherein the user interface comprises a slider bar and wherein to obtain the first data associated with the category, the instructions cause the system to obtain a slider cursor position relative to the slider bar.

15. The system of claim 9, wherein the instructions further cause the system to determine, based on the plurality of third values, a plurality of respective minimum values and a plurality of respective maximum values for respective geographic locations.

16. The system of claim 15, wherein to adjust, based on the scale factor, the plurality of third values to obtain the plurality of fourth values, the instructions cause the system to, for each geographic location:
subtract a respective minimum value from a respective maximum value to obtain a respective delta value;
multiply the respective delta value by the first data to obtain a respective product value; and
add the respective minimum value to the respective product value.

17. A non-tangible computer readable storage medium storing instructions that, when executed, cause one or more processors to:
determine, for a category, a plurality of first values and a plurality of second values, wherein respective first values from the plurality of the first values and respective second values from the plurality of the second values are associated with respective permutations of parameters associated with the category;
determine, based on the plurality of first values and the plurality of second values, a plurality of third values;
determine, based on the plurality of third values, a minimum value and a maximum value;
obtain, via a user interface, first data associated with the category;
determine, based on the minimum value, the maximum value, and the first data, a scale factor;
adjust, based on the scale factor, the plurality of third values to obtain a plurality of fourth values; and
output the plurality of fourth values.

18. The storage medium of claim 17, wherein to determine the scale factor, the instructions, when executed, cause the one or more processors to interpolate between the minimum value and the maximum value based on the first data.

19. The storage medium of claim 17, wherein the user interface comprises a slider bar and wherein to obtain the first data associated with the category, the instructions, when executed, cause the one or more processors to obtain a slider cursor position relative to the slider bar.

20. The storage medium of claim 17, wherein the instructions, when executed, further cause the one or more processors to determine, based on the plurality of third values, a plurality of respective minimum values and a plurality of respective maximum values for respective geographic locations.
